(19) United States
(12) Patent Application Publication
(10) Pub. No.: US 2005/0013930 A1
(43) Pub. Date: Jan. 20, 2005

(54) Apparatus and method for cleaning, painting and/or treating traffic barriers

(76) Inventor: Robert M. Killmer SR., Langhorne, PA (US)

Correspondence Address: Eric A. LaMorte;LaMorte & Associates, P.C., P.O. Box 434, Yardley, PA, 19067, US

(21) Appl. No.: 10/621,593

(22) Filed: Jul. 18, 2003

(51) Int. Cl. B05D 5/10

(52) U.S. Cl. 427/136; 427/421.1; 118/300; 239/130

(57) ABSTRACT

An assembly and method for spraying material on a traffic barrier. At least one vehicle is provided that travels along the length of the traffic barrier while contacting the traffic barrier and being guided by the traffic barrier. With each vehicle is one or more spray head arrays that spray the surfaces of the traffic barrier as the vehicle rolls along the traffic barrier. The spray heads can spray either cleaning material or coating materials. Both cleaning and coating can be preformed by spray head arrays in the same vehicle or in different vehicles. The spray heads can be automatically adjusted to match variations encountered in the traffic barrier as the spray head arrays are moved along the traffic barrier. In this manner, the quality of the application of sprayed material remains constant despite changes in the shape and/or condition of the traffic barrier being sprayed.

### BACKGROUND OF THE INVENTION

1. Field of the Invention

In general, the present invention relates to machines that automatically clean, paint or treat concrete surfaces. More particularly, the present invention relates to mobile machines that clean, paint or treat concrete surfaces as the machine moves along such surfaces.

2. Background of the Invention

When roadways are created, it is not uncommon for traffic barriers to be erected between opposing lanes of traffic. There are many different types of traffic barriers. However, the function of most all traffic barriers remains the same. Traffic barriers are used to help keep vehicles in their own lane of traffic and prevent vehicles from inadvertently crossing lanes, leaving the roadway or otherwise traveling onto an area where vehicles should not travel.

Although traffic barriers come in many different styles and are fabricated from metal, stone, wood and cable, one of the most common types of traffic barrier is the cement traffic barrier. Cement traffic barriers are typically prefabricated in lengths of between four feet and twenty feet. The preformed cement traffic barriers are then transported to a roadway and placed into position with a crane. As such, they can be placed along a roadway quickly and inexpensively.

There are many different manufacturers of cement traffic barriers. As a result, there are many different shapes and styles of cement traffic barriers. Many of these different styles of cement traffic barriers have different methods of interconnecting and different processes for installation. However, most all cement traffic barriers, regardless of the manufacturer, have wide bases that taper upwardly to a narrower top. This tends to provide the cement traffic barrier with a frustum shaped profile.

Cement traffic barriers are commonly used as temporary traffic barriers during roadway construction and maintenance projects. However, due to their low cost and ease of installation, more and more state and local transportation departments are installing cement traffic barriers as permanent structures on the sides of finished roadways. When cement traffic barriers are installed as permanent roadside fixtures, transportation departments typically devise maintenance schedules for maintaining the cement traffic barriers over long periods of time. Such maintenance is to prevent the cement traffic barriers from deteriorating as a result of weathering, contact with vehicles and other forms of damage.

A typical maintenance program for cement traffic barriers is to have the traffic barriers periodically inspected and repaired. After repairs, the cement traffic barriers are often cleaned and painted with either paint or a cement sealant to prevent water from seeping into the interior of the cement traffic barriers.

In the prior art, there are many machines used to clean cement structures. Such prior art machines are exemplified by U.S. Pat. No. 5,004,156 to Montanier, entitled Washing Device Mounted On A Motor Vehicle And Comprising A Rotary Washing Arm Which Delivers Jets Of Pressurized Hot Water For Cleaning Various Surfaces. Such machines typically include sand blasting heads and power washing heads that are disposed on the end of an articulating arm. The arm can be placed against a wall, traffic barrier, bridge support or any other surface that needs cleaning. Once the surface is cleaned, the cleaned surface is then painted manually.

Cement traffic barriers can extend for many miles along the length of a roadway. Using cleaning machines on articulating arms that clean only small sections at a time are not well suited for cleaning the full length of many cement traffic barriers. Furthermore, relying upon manual labor to hold painting equipment and carry it along the length of the roadway is also highly labor intensive and inefficient. In fact, it has been the experience of many municipalities that it is more cost effective to replace worn and broken cement traffic barriers after a long period of use than it is to maintain those traffic barriers indefinitely.

A need therefore exists for an apparatus and method that can be used to both clean and paint cement traffic barriers in a cost effective, time efficient and non-labor intensive manner. This need is met by the present invention as described and claimed below.

### SUMMARY OF THE INVENTION

The present invention is an assembly and method for spraying material on a traffic barrier. The assembly includes at least one vehicle that travels along the length of the traffic barrier while contacting the traffic barrier and being guided by the traffic barrier. With each vehicle is one or more spray head arrays that spray the surfaces of the traffic barrier as the vehicle rolls along the traffic barrier. The spray heads can spray either cleaning material, such as air, water, cleaning solution, solvents and abrasives, or coating materials, such as paint or waterproofing solutions. Both cleaning and coating can be preformed by spray head arrays in the same vehicle or in different vehicles. The spray heads can be automatically adjusted to match variations encountered in the traffic barrier as the spray head arrays are moved along the traffic barrier. In this manner, the quality of the application of sprayed material remains constant despite changes in the shape, position, orientation and/or condition of the traffic barrier being sprayed.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a perspective view of an exemplary embodiment of the present invention barrier maintenance assembly;

FIG. 2 is a schematic illustrating the components of the embodiment of the barrier maintenance assembly shown in FIG. 1;

FIG. 3 is a schematic illustration showing how guide wheels are initially positioned around a cement traffic barrier;

FIG. 4 is a schematic illustration showing how guide wheels contact a cement traffic barrier;

FIG. 5 is a schematic showing how spray head arrays are positioned around a segment of a cement traffic barrier;

FIG. 6 is a side view of an alternate embodiment of a barrier maintenance assembly.

### DETAILED DESCRIPTION OF THE INVENTION

Although the present invention can be used to clean and/or paint many types of roadside structures, such as metal traffic barriers, stone traffic barriers and the like, the present invention is particularly well suited for cleaning and/or painting cement traffic barriers. As such, the present invention will be described and illustrated in an application where it is being used to clean and paint a cement traffic barrier in order to set forth the best mode contemplated for the invention.

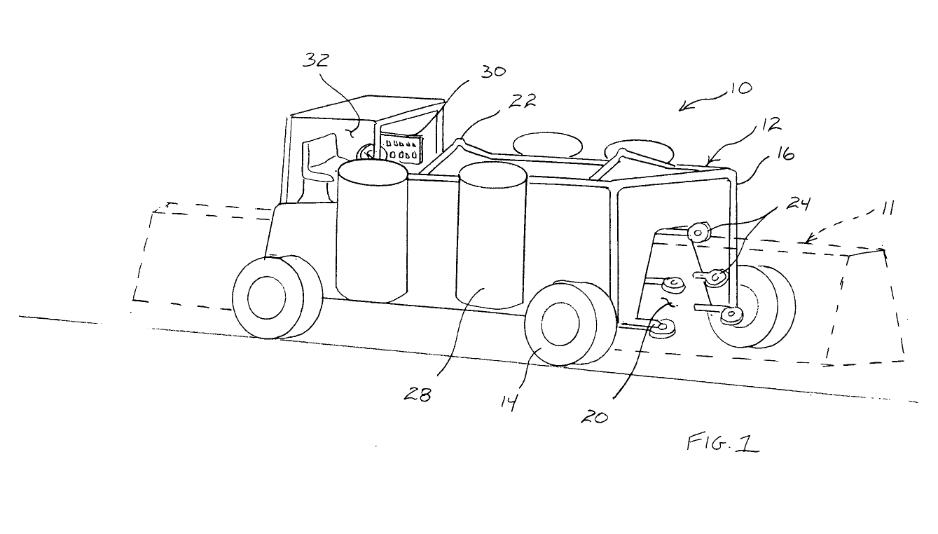

Referring to FIG. 1, there is shown an exemplary embodiment of the present invention barrier maintenance assembly 10. In the shown embodiment the present invention barrier maintenance assembly 10 is configured as a self-propelled vehicle 12. The vehicle 12 is configured so that it can straddle a cement traffic barrier 11 and move along the length of the cement traffic barrier 11 under its own power. As will later be explained in more detail, the barrier maintenance assembly 10 is placed over a cement traffic barrier 11 so that its wheels 14 rest upon the ground on opposite sides of the cement barrier 11. As the barrier maintenance assembly 10 moves along the cement traffic barrier 11, it cleans, paints and/or treats the surfaces of the cement traffic barrier 11.

From FIG. 1, it can be seen that the exemplary vehicle 12 has a frame 16. The frame 16 is configured with a large open center channel 20 that enables the vehicle 12 to be placed over the cement traffic barrier 11 so that the wheels 14 of the vehicle 12 can straddle the concrete traffic barrier 11. The frame 16 has crane hooks 22 that are used to couple the frame 16 of the vehicle 12 to a crane or other overhead lift. As such, through the use of a crane, the vehicle 12 can be placed onto or removed from a length of cement traffic barrier 11 at any point.

At the front of the open channel 20 in the frame 16 is a plurality of guide wheels 24. The guide wheels 24 serve two functions. First, they prevent the frame 16 of the vehicle 12 from contacting the cement traffic barrier 11 as the vehicle 12 rides along the cement traffic barrier 11. Secondly, the guide wheels 24 act as gauges for setting the internal mechanisms of the barrier maintenance assembly 10, as it cleans, paints and/or treats the cement traffic barrier 11.

Refillable storage containers 28 are disposed on the vehicle 12. The storage containers 28 are used to store, paint, waterproofing compounds, cleaning solution or any other product that used to clean, paint and/or treat the cement traffic barrier 11. The storage containers 28 are preferably disposed on the exterior of the vehicle frame 16 so that they can be easily replenished and can be made large to hold a large volume of material.

In the shown embodiment of the barrier maintenance assembly 10, the vehicle 12 is self-propelled. Accordingly, a driver must drive the vehicle 12. A driver cab 32 is therefore provided containing the movement controls of the vehicle 12. Additionally, the operational controls 30 for the mechanisms that clean, paint and/or treat the cement traffic barrier are also disposed in the driver cab 32 so that they can be manually operated.

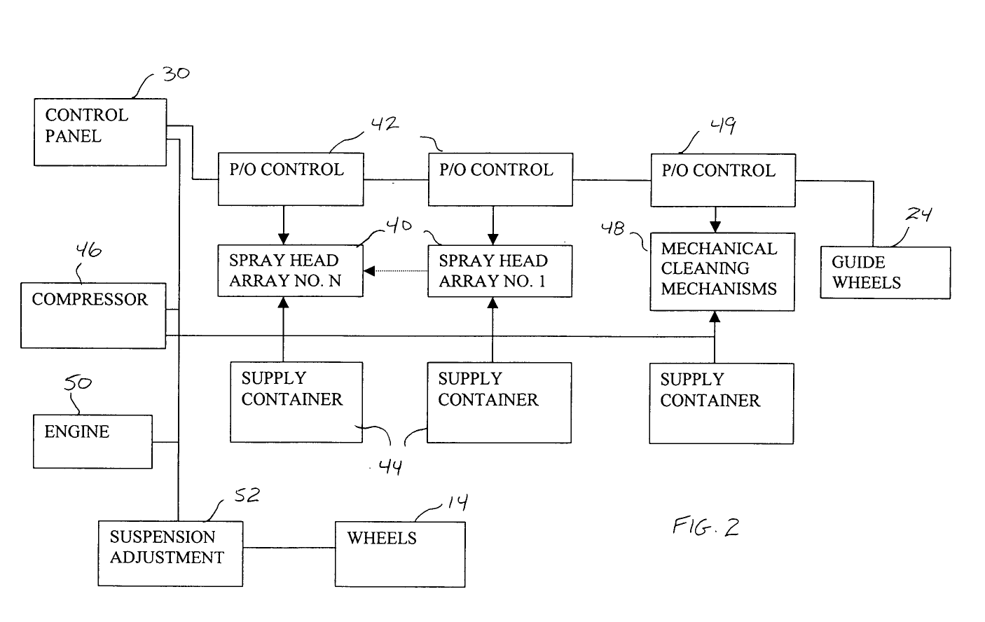

Referring to FIG. 2, it will be understood that present invention barrier maintenance assembly 10, embodied in the vehicle 12 of FIG. 1 includes at least one of a variety of mechanisms for cleaning, painting and or treating the concrete traffic barrier as the vehicle passes over the concrete traffic barrier. From FIG. 2 it can be seen that at least one spray head array 40 is present within the assembly 10. Each spray head array 40 has spray heads that are pointed toward the channel 20 (FIG. 1) that passes down the center of the vehicle 12 (FIG. 1). As such, when the vehicle straddles a cement traffic barrier and the cement traffic barrier passes through the channel in the center of the vehicle, the spray head arrays 40 are positioned to spray the passing surfaces of the cement traffic barrier.

Each spray head array 40 is coupled to a positional and operational control 42. As indicated by the name, the positional and operational control 42 controls the position of the various spray heads in each spray head array 40 and the operation of those spray heads.

Each spray head array 40 is coupled to a supply tank 44 and a compressor 46. The compressor 46 supplies compressed air for the spray heads in the spray head array 40. The material in the storage tanks 44 can be sprayed with the compressed air by the spray head arrays 40. The material in the storage tanks 44 depends upon the decided purpose of a particular spray head array 40. For example, if a spray head array 40 is to spray paint onto the surfaces of a passing cement traffic barrier then paint is supplied in the storage tank 44. Similarly, if a waterproofing treatment is to be sprayed on the surfaces of a passing cement traffic barrier then the waterproofing solution is supplied in the storage tank 44. Other materials that can commonly be sprayed may include water, cleaning solution, paint solvent and the like.

Solid material can also be sprayed by one or all of the spray head arrays 40. A spray head array 40 can be configured so that it sprays sand against the surfaces of a passing cement traffic barrier. In such a sandblasting process, naturally sand or a similar abrasive would be supplied in the supply tank 44 of the spray head array 40.

The supply tank 44 of a particular spray head array 40 can also be isolated from that spray head array 40. In such a configuration, just compressed air is sprayed by the spray heads in the spray head array 40. Such a spray configuration can be used to air blast clean the surfaces of the passing cement traffic barrier.

In the shown embodiment, there is a plurality of different spray head arrays 40. Each spray head array 40 can have the same or different function. For instance, a first spray head array can be used to air blast the surfaces of a cement traffic barrier while a second and third spray head array spray coating of paint onto the cement traffic barrier.

In FIG. 2, it can be seen that an optional mechanical cleaning mechanism 48 can be placed in front of the first spray head array 40. The mechanical cleaning mechanism 48 can be a series of spinning brushes, spinning chains or any other cleaning mechanism that physically contacts the surfaces of the cement traffic barrier to dislodge dirt, grime, old paint or other accumulated debris. If a mechanical cleaning mechanism 48 is present, it too is provided with a positional and operational control 49 that is used to control the position and operation of the mechanism.

The positional and operational controls 42, 49 of the various spray head arrays 40 and the mechanical cleaning mechanism 48 are coupled to the manual control panel 30 of the barrier maintenance assembly 10 so that they can be manually controlled by an operator. Furthermore, the guide wheels 24 are used to either mechanically or electronically provide information that is used to set the various positional and operational controls 42, 49. The guide wheels 24 roll along the surfaces of the passing cement barrier structure. The guide wheels 24 contact the surfaces of the cement traffic barrier. As such, the guide wheels 24 physically detect the dimensions of the cement traffic barrier and can detect when the shape, size or position of the cement traffic barrier changes as it passes into the barrier maintenance assembly 10.

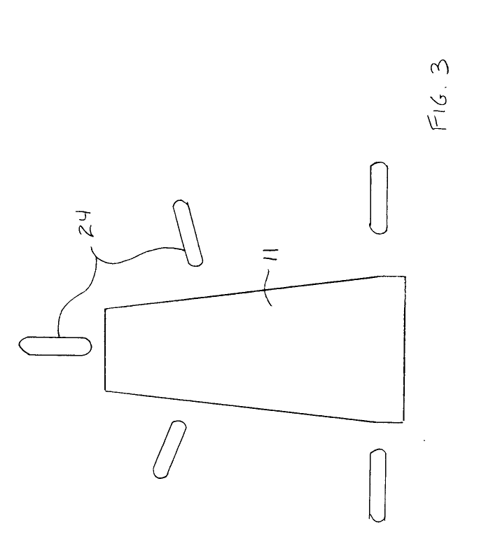

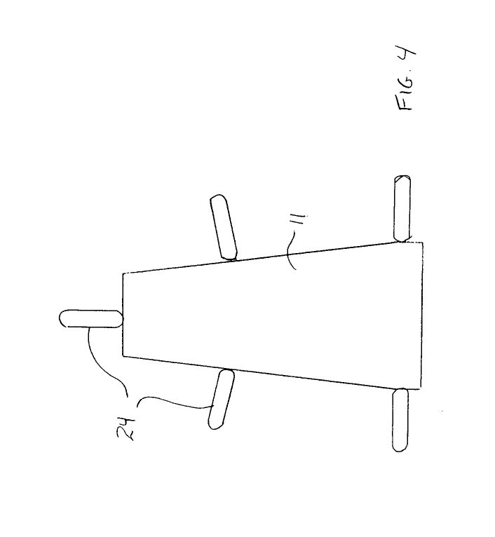

Referring to FIG. 3, it can be seen that when the barrier maintenance assembly 10 is first placed over a cement traffic barrier 11, the guide wheels 24 are retracted and do not contact the cement traffic barrier 11. Referring to FIG. 2, it can be seen that once the barrier maintenance assembly 10 is in place, the guide wheels 24 are brought into contact with at least some of the various surfaces of the cement traffic barrier 11. In FIG. 4, a plurality of guide wheels 24 are used. By bringing the guide wheels 24 into contact with the surfaces of the cement traffic barrier 11, it can be seen that the cross-sectional shape of the cement traffic barrier 11 can be determined including its height, width and angle of taper.

Once the guide wheels 24 are brought into contact with the surfaces of the cement traffic barrier 11, the dimensions obtained from the position of the guide wheels 24 can be transferred either manually, physically or electronically to the positional and operational controls 42 (FIG. 2) of the spray head arrays 40 (FIG. 2) and the positional and operational controls 49 (FIG. 2) of the mechanical cleaning mechanism 48 (FIG. 2).

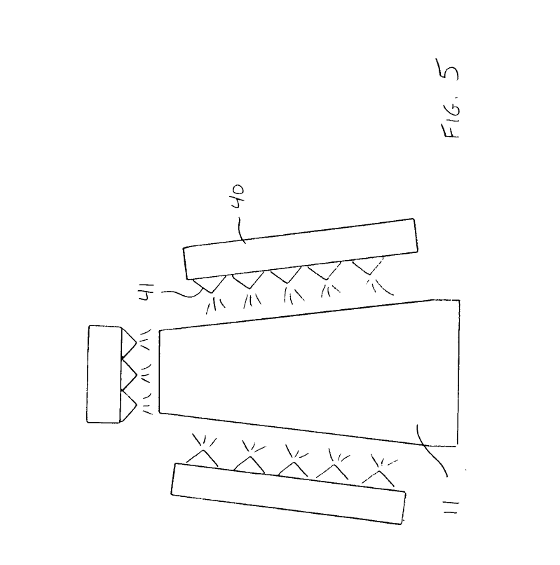

Referring to FIG. 5, it can be seen that the various spray heads 41 in a spray head array 40 can be positioned with information received from the guide wheels 24 (FIG. 4) to properly spray the passing cement traffic barrier 11. Since the guide wheels constantly detect changes in the shape of the passing concrete traffic barrier 11 the spray heads 41 can also be constantly adjusted to ensure that the application quality of the material being sprayed remains relatively constant.

Returning to FIG. 2, it can be seen that since the barrier maintenance assembly 10 is embodied as a vehicle 12, the assembly 10 includes an engine 50 for propelling the vehicle 12. The engine 50 is also used to drive the compressor 46 that supplies compressed air to the various spray head arrays 40. The engine 50 drives at least two of the wheels 14 of the vehicle 12 to propel the vehicle 12. The vehicle 12 is manually driven and has a transmission designed to propel the vehicle 12 along a length of cement traffic barrier 11 at a speed of between two miles per hour and ten miles per hour.

A suspension adjustment mechanism 52 may also be provided. The suspension adjustment mechanism 52 is manually controlled and controls the height of the vehicle frame above the ground. Different types of cement traffic barriers vary greatly in height. Some stand slightly larger than curbs. Some can stand five feet tall. The use of the suspension adjustment mechanism allows an operator to set the general height of the barrier maintenance assembly 10 so that it is properly positioned for the height of the cement traffic barrier being maintained. Small variation in the size and height of the cement traffic barrier are not compensated for with the suspension adjustment mechanism, but are rather adjusted by using the positional and operational controls of the various spray head arrays 40.

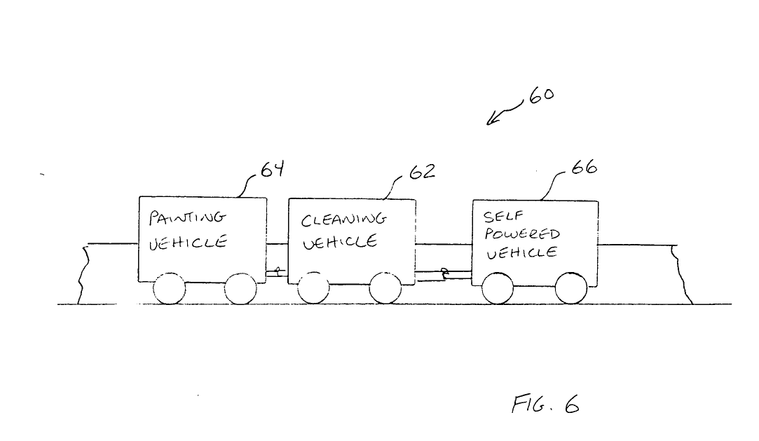

In the embodiment of the present invention barrier maintenance assembly 10 shown in FIG. 1 and FIG. 2, the barrier maintenance assembly 10 has multiple spray head arrays in a single machine. Such an embodiment is merely exemplary and it should be understood that barrier maintenance assemblies can be made containing only one or two spray head arrays. Such an embodiment is set forth in FIG. 6. In FIG. 6 it can be seen that the barrier maintenance assembly 60 is divided into different dedicated vehicles. In the shown embodiment, there is a cleaning vehicle 62. The cleaning vehicle 62 may contain spray heads that air blast the cement traffic barrier or spray heads that spray water and cleaner against the cement traffic barriers. A separate vehicle can be constructed as a painting vehicle 64. The painting vehicle 64 contains spray head arrays that spray paint or waterproofing treatment onto the concrete traffic barrier 11.

Each vehicle 62, 64 contains the guide wheels and adjustment mechanisms previously described. Each of the vehicles 62, 64 can contain an engine and can be self-propelling. However, each vehicle 62, 64 can be made simply to be free rolling. A single self-powered vehicle 66 can then be provided to pull the various free rolling vehicles 62, 64. Units can be pulled one at a time or can be coupled together like freight cars of a train. In the shown embodiment, the self-powered vehicle 66 is shown as a dedicated machine that straddles the cement traffic barrier 11. However, the self-powered vehicle 66 can be an ordinary truck that pulls the free-rolling vehicles 62, 64 by driving along the side of the cement traffic barrier.

It will be understood that the embodiments of the present invention barrier maintenance system that are described and illustrated herein are merely exemplary and a person skilled in the art can make many variations to the embodiment shown without departing from the scope of the present invention. All such variations, modifications and alternate embodiments are intended to be included within the scope of the present invention as defined by the appended claims.

1. An assembly for spraying material on a traffic barrier having a plurality of surfaces, said assembly comprising:
a frame defining an open area through which the traffic barrier can pass;
wheels coupled to said frame enabling said frame to roll along a length of the traffic barrier; and
at least one spray head array supported by said frame, wherein said at least one spray head array sprays material on at least one of the surfaces of the traffic barrier as the traffic barrier passes through said open area.

2. The assembly according to claim 1, wherein said frame straddles the traffic barrier supporting wheels on opposite sides of the traffic barrier.

3. The assembly according to claim 1, wherein said material sprayed by said at least one spray head array is selected from a group consisting of: paints, waterproofing solutions, solvents, solid abrasives, air, water and cleaning solutions.

4. The assembly according to claim 1, further including an engine for propelling said frame along a length of traffic barrier.

5. The assembly according to claim 1, further including guide wheels, supported by said frame that contact and roll along the plurality of surfaces of the traffic barrier.

6. The assembly according to claim 5, further including positional controls for selectively adjusting said at least one spray head array.

7. The assembly according to claim 6, wherein said positional controls are coupled to said guide wheels and receive information about the traffic barrier from said guide wheels.

8. The assembly according to claim 1, further including a mechanical cleaning mechanism supported by said frame for contacting and mechanically cleaning the traffic barrier as the traffic barrier passes through said open area.

9. A method of maintaining surfaces of a traffic barrier, comprising the steps of:
providing spray heads that spray material;
orienting said spray heads in a frame to spray said material in a predetermined area; and
rolling said frame along the traffic barrier so that surfaces of the traffic barrier pass through said predetermined area and receive said spray material.

10. The method according to claim 9, wherein said step of orienting said spray heads in a frame includes orienting spray head along opposing sides of the traffic barrier.

11. The method according to claim 9, wherein said material sprayed by said spray heads is selected from a group consisting of: paints, waterproofing solutions, solvents, solid abrasives, air, water and cleaning solutions.

12. The method according to claim 9, wherein said step of rolling said frame along the traffic barrier includes providing an engine for propelling said frame along a length of the traffic barrier.

13. The method according to claim 9, wherein said step of orienting said spray heads in a frame includes the substeps of:
detecting changes in dimensions of the traffic barrier as said frame rolls along the traffic barrier; and
adjusting said spray heads to compensate for changes in dimensions detected.

14. The method according to claim 13, wherein said substep of detecting changing in dimensions includes contacting the traffic barrier with guide wheels, wherein said guide wheels roll along the traffic barrier and physical changes in the traffic barrier.

15. A method of cleaning and spraying a traffic barrier, said method comprising the steps of:
advancing a first set of spray heads along the traffic barrier that are guided by the traffic barrier, wherein said first set of spray heads spray a cleaning material onto surfaces of the traffic barrier; and
advancing a second set of spray heads along the traffic barrier that are guided by the traffic barrier, wherein said second set of spray heads spray a coating material onto said surfaces of the traffic barrier.

16. The method according to claim 15, wherein said cleaning material is selected from a group consisting of air, abrasives, cleaning solution, water and solvents.

17. The method according to claim 15, wherein said coating material is selected from a group consisting of paint and waterproofing compounds.

18. The method according to claim 15, wherein said step of advancing a first set of spray heads along the traffic barrier includes positioning the first set of spray heads in a vehicle that straddles the traffic barrier and rolls along the traffic barrier.

19. The method according to claim 15, wherein said step of advancing a second set of spray heads along the traffic barrier includes positioning the second set of spray heads in a vehicle that straddles the traffic barrier and rolls along the traffic barrier.
